(19) United States
(12) Patent Application Publication
(10) Pub. No.: US 2025/0033267 A1
(43) Pub. Date: Jan. 30, 2025

(54) MANUFACTURING METHOD FOR THREE DIMENSIONAL MOLDED OBJECT

(71) Applicant: SEIKO EPSON CORPORATION, Tokyo (JP)

(72) Inventor: Manabu WATANABE, SHIOJIRI-SHI (JP)

(21) Appl. No.: 18/783,579

(22) Filed: Jul. 25, 2024

(30) Foreign Application Priority Data
Jul. 26, 2023 (JP) 2023-121611

(51) Int. Cl. B29C 64/106; B29C 64/209; B29C 64/232; B29C 64/321; B29C 64/386; B33Y 10/00; B33Y 50/00

(52) U.S. Cl. CPC B29C 64/106; B29C 64/209; B29C 64/232; B29C 64/321; B29C 64/386; B33Y 10/00; B33Y 50/00

(57) ABSTRACT

A manufacturing method for an three dimensional molded object includes a first step of plasticizing a material to produce a plasticized material; a second step of forming the layer on a stage by moving a nozzle relative to the stage while ejecting the plasticized material from a nozzle opening; and a third step of stopping the ejection of the plasticized material during a movement time in which the nozzle relatively moves from an ejection stop position to an ejection restart position, wherein in the third step, a first control is performed to control the movement of the nozzle such that a difference between a first movement time, which is the movement time in a first case where a distance is a first distance, and a second movement time, which is the movement time in a second case where the distance is a second distance shorter than the first distance.

The present application is based on, and claims priority from JP Application Serial Number 2023-121611, filed Jul. 26, 2023, the disclosure of which is hereby incorporated by reference herein in its entirety.

### BACKGROUND

### 1. Technical Field

The present disclosure relates to a method for manufacturing a three dimensional molded object.

### 2. Related Art

JP-A-2019-81263 discloses a three dimensional molding device including a flow rate adjustment mechanism capable of controlling the amount of a molten material ejected from a nozzle. In the three dimensional molding device, a non-ejection control for stopping the ejection of the material from the nozzle is performed by adjusting the rotation angle of a butterfly valve. The non-ejection control is performed when it is desired to change the nozzle position in a state where the molten material is not being ejected from the nozzle.

In the step of molding the three dimensional molded object, there is a case where the non-ejection control is performed a plurality of times and the periods from the ejection stop to the ejection restart in the non-ejection control of the plurality of non-ejection controls are not the same. In this case, the pressure in the flow path upstream of the butterfly valve may differ for each non-ejection control, and the ejection amount at the time of ejection restart may differ for each non-ejection control.

### SUMMARY

According to one aspect of the present disclosure, there is provided a three dimensional molding device for molding a three dimensional molded object by stacking layers.

This manufacturing method includes a first step of plasticizing a material to produce a plasticized material and sending the plasticized material toward a nozzle opening of a nozzle; a second step of forming a layer on a stage by moving the nozzle relative to the stage while ejecting the plasticized material from the nozzle opening; and a third step of stopping the ejection of the plasticized material from the nozzle opening during a movement time in which the nozzle relatively moves with respect to the stage from an ejection stop position at which ejection from the nozzle opening is stopped to an ejection restart position that is positioned in the same layer as the ejection stop position and that is where ejection from the nozzle opening is restarted, wherein in the third step ejection of the plasticized material from the nozzle opening is stopped by adjusting an opening area of a flow path through which the plasticized material flows toward the nozzle opening and a first control is performed to control the movement of the nozzle with respect to the stage such that a difference between a first movement time and a second movement time is within a predetermined range, the first movement time being the movement time in a first case where a movement distance, which is a distance from the ejection stop position to the ejection restart position, is a first distance, and the second movement time being the movement time in a second case where the movement distance is a second distance shorter than the first distance.

### BRIEF DESCRIPTION OF THE DRAWINGS

FIG. 1 is an explanatory diagram showing a schematic configuration of a three dimensional molding system.

FIG. 2 is a perspective diagram showing a schematic configuration of a screw.

FIG. 3 is a schematic plan diagram of a barrel.

FIG. 4 is an explanatory diagram schematically showing how a three dimensional molding device molds a molded object.

FIG. 5 is an explanatory diagram showing a schematic configuration of an information process device.

FIG. 6 is a flowchart of a molding data generation process.

FIG. 7 is a diagram showing molding data.

FIG. 8 is a graph showing a relationship between time and pressure.

FIG. 9 is a graph showing a relationship between a movement distance and a movement speed and the relationship between a movement distance and a movement time.

FIG. 10 is a flowchart of a molding process.

FIG. 11 is a diagram showing the movement of a non-ejection path in a second embodiment.

FIG. 12 is a diagram for explaining the molding data in a third embodiment.

### DESCRIPTION OF EMBODIMENTS

### A. First Embodiment

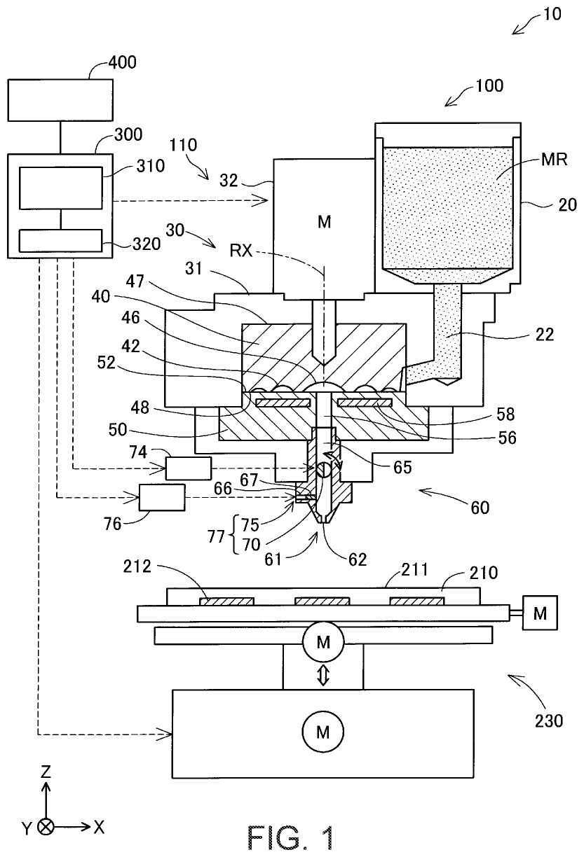

FIG. 1 is an explanatory diagram showing a schematic configuration of a three dimensional molding system 10 in the first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are appropriately shown in other drawings so that the shown directions correspond to those in FIG. 1. In the following description, when a direction is specified, a direction indicated by an arrow in each drawing is referred to as “+” and an opposite direction is referred to as “−”, and positive and negative signs are used in combination for direction notation. Hereinafter, the +Z direction is also referred to as “upper”, and the −Z direction is also referred to as “lower”.

The three dimensional molding system 10 includes a three dimensional molding device 100 and an information process device 400. The three dimensional molding device 100 of the present embodiment is a device that molds a molded object by a material extrusion method. The three dimensional molding device 100 includes a control section 300 for controlling each section of the three dimensional molding device 100. The control section 300 and the information process device 400 are communicably connected to each other.

The three dimensional molding device 100 includes a head section 110 that produces and ejects a plasticized material, a stage 210 for molding serving as a base of the molded object, and a movement mechanism 230 that controls an ejection position of the plasticized material.

Under the control of the control section 300, the head section 110 ejects the plasticized material obtained by plasticization of the material in a solid state onto the stage 210. The head section 110 includes a material supply section 20, which is a supply source of raw material before being converted into the plasticized material, a plasticizing section 30, which converts the raw material into the plasticized material, and an ejection section 60, which ejects the plasticized material.

The material supply section 20 supplies raw material MR to the plasticizing section 30. The material supply section 20 is constituted by, for example, a hopper for containing the raw material MR. The material supply section 20 is connected to the plasticizing section 30 via a communication path 22. The raw material MR is supplied to the material supply section 20 in the form of powder or pellet. As the raw material MR, for example, a resin material such as acrylonitrile butadiene styrene (ABS), polyetheretherketone (PEEK), or polypropylene (PP) is used.

The plasticizing section 30 plasticizes the raw material MR supplied from the material supply section 20 to produce a pasty plasticized material exhibiting fluidity, and guides the plasticized material to the ejection section 60. In the present embodiment, “plasticization” is a concept including melting, and is a change from a solid state to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is set to be equal to or higher than the melting point.

The plasticizing section 30 includes a screw case 31, a drive motor 32, a screw 40, and a barrel 50. The screw 40 is also referred to as a flat screw, a rotor, or a scroll. The barrel 50 is also referred to as a screw facing section.

The screw 40 is housed in the screw case 31. An upper surface 47 of the screw 40 is connected to the drive motor 32, and the screw 40 is rotated in the screw case 31 by a rotational driving force generated by the drive motor 32. The drive motor 32 is driven under the control of the control section 300. Note that the screw 40 may be driven by the drive motor 32 via a decelerator.

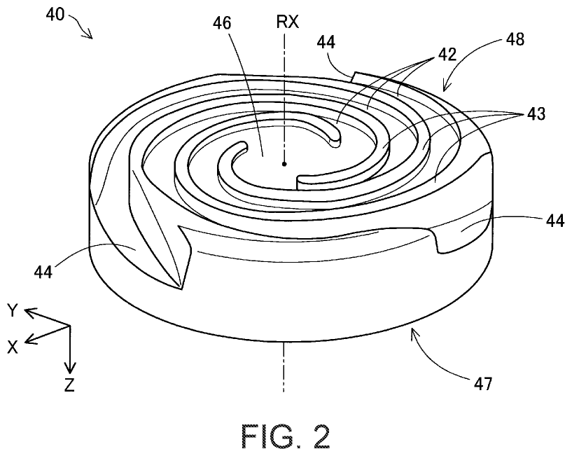

FIG. 2 is a perspective view showing a schematic configuration of a lower surface 48 side of the screw 40. The screw 40 shown in FIG. 2 is shown in a state in which the positional relationship between the upper surface 47 and the lower surface 48 shown in FIG. 1 is reversed in the vertical direction for easy understanding of the technology. The screw 40 has a substantially cylindrical shape in which a length in an axial direction, which is a direction along a central axis of the screw 40, is smaller than a length in a direction perpendicular to the axial direction. The screw 40 is disposed such that a rotation axis RX serving as a rotation center thereof is parallel to the Z direction.

Vortex groove sections 42 are formed in a lower surface 48 of the screw 40, which is a surface intersecting the rotation axis RX. The communication path 22 of the material supply section 20 described above communicates with the groove sections 42 from the side surface of the screw 40. In the present embodiment, the groove sections 42 are formed by three sections spaced apart by ridge sections 43. Note that the number of groove sections 42 are not limited to three, and may be one or two or more. The groove sections 42 are not limited to a vortex shape, may be helical or involute curvilinear, and may extend so as to draw an arc from the central section to the outer periphery.

As shown in FIG. 1, the lower surface 48 of the screw 40 faces an upper surface 52 of the barrel 50, and a space is formed between the groove sections 42 of the lower surface 48 of the screw 40 and the upper surface 52 of the barrel 50. This space between the screw 40 and the barrel 50 is supplied with the raw material MR from the material supply section 20 through a material inflow port 44 shown in FIG. 2.

The barrel 50 is embedded with a barrel heater 58 for heating the raw material MR supplied into the groove sections 42 of the rotating screw 40. A communication hole 56 is provided at the center of the barrel 50.

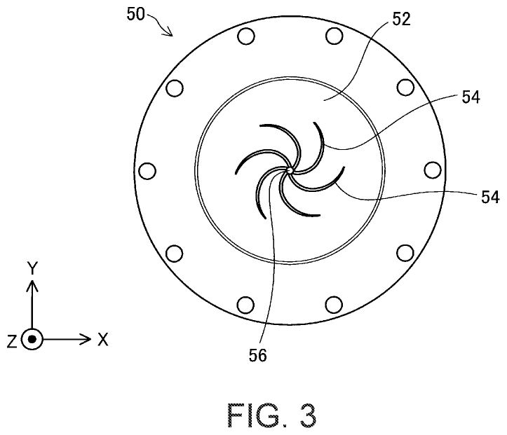

FIG. 3 is a schematic plan diagram showing the upper surface 52 side of the barrel 50. On the upper surface 52 of the barrel 50, a plurality of guide grooves 54 are formed, which are connected to the communication hole 56 and extend in the vortex shape from the communication hole 56 toward the outer periphery. Note that one end of the guide grooves 54 may not be connected to the communication hole 56. It is also possible to omit the guide grooves 54.

The raw material MR supplied into the groove sections 42 of the screw 40 is plasticized in the groove sections 42, flows along the groove sections 42 by the rotation of the screw 40, and is guided to a central section 46 of the screw 40 as the plasticized material. The pasty plasticized material exhibiting fluidity, which has flowed into the central section 46, is supplied to the ejection section 60 via the communication hole 56 provided at the center of the barrel 50. Note that in the plasticized material, not all types of substances that make up the plasticized material need to be plasticized. The plasticized material may be converted into a state having fluidity as a whole by plasticization of at least some kinds of substances among substances constituting the plasticized material.

The ejection section 60 of FIG. 1 includes a nozzle 61 that ejects the plasticized material, a flow path 65 of the plasticized material provided between the screw 40 and a nozzle opening 62, and an ejection control section 77 that controls the eject of the plasticized material.

The nozzle 61 is connected to the communication hole 56 of the barrel 50 through the flow path 65. The nozzle 61 ejects the plasticized material produced in the plasticizing section 30 toward the stage 210 from the nozzle opening 62 at the tip end.

The ejection control section 77 includes an ejection amount adjustment mechanism 70 that opens and closes the flow path 65 and a suction mechanism 75 that suctions and temporarily stores the plasticized material.

The ejection amount adjustment mechanism 70 is provided inside the flow path 65 and changes the opening degree of the flow path 65 by rotating in the flow path 65. In the present embodiment, the ejection amount adjustment mechanism 70 is constituted by a valve. The ejection amount adjustment mechanism 70 is driven by a first drive section 74 under the control of the control section 300. The first drive section 74 is constituted by, for example, a stepping motor. The control section 300, using the first drive section 74, by controlling the rotation angle of the valve, can adjust the flow rate of the plasticized material flowing from the plasticizing section 30 to the nozzle 61, that is, the ejection amount of the plasticized material ejected from the nozzle 61. The ejection amount adjustment mechanism 70 can adjust the ejection amount of the plasticized material and can control the on/off of the outflow of the plasticized material.

The suction mechanism 75 includes a branch flow path 66 connected to the flow path 65, and a plunger 67 disposed in the branch flow path 66. The branch flow path 66 is connected to the flow path 65 between the ejection amount adjustment mechanism 70 and the nozzle opening 62. Hereinafter, moving the plunger 67 away from the flow path 65 in the branch flow path 66 is referred to as “pulling the plunger 67” and moving the plunger 67 closer to the flow path 65 is referred to as “pushing the plunger 67”. The plunger 67 of the suction mechanism 75 is driven by a second drive section 76 under the control of the control section 300. The second drive section 76 is constituted by, for example, a stepping motor, a rack and pinion mechanism for converting a rotational force of the stepping motor into a translational motion of the plunger 67, or the like.

The control section 300 controls the suction mechanism 75 to temporarily suck the plasticized material in the flow path 65 into the branch flow path 66 by pulling the plunger 67 when the ejection of the plasticized material from the nozzle 61 is stopped. By doing so, it is possible to suppress a tailing phenomenon in which the plasticized material drips from the nozzle opening 62 in a string-like manner.

The stage 210 is disposed at a position facing the nozzle opening 62 of the nozzle 61. In the first embodiment, a molding surface 211 of the stage 210 facing the nozzle opening 62 of the nozzle 61 is disposed so as to be parallel to the X and Y directions, that is, a horizontal direction. The stage 210 is provided with a stage heater 212 for suppressing rapid cooling of the plasticized material ejected onto the stage 210. The stage heater 212 is controlled by the control section 300.

The movement mechanism 230 changes the relative position between the stage 210 and the nozzle 61 under the control of the control section 300. In the present embodiment, the position of the stage 210 is fixed and the movement mechanism 230 moves the nozzle 61. The movement mechanism 230 is constituted by a three-axis positioner that moves the nozzle 61 in three axial directions in the X, Y, and Z directions by the driving force of three motors. In the present specification, unless otherwise specified, the movement of the nozzle 61 means that the nozzle 61 or the ejection section 60 is moved relative to the stage 210. The range of the movement speed of the nozzle 61 by the movement mechanism 230 is set within a predetermined speed range.

Note that in another embodiment, instead of the configuration in which the nozzle 61 is moved by the movement mechanism 230, a configuration in which the movement mechanism 230 moves the stage 210 with respect to the nozzle 61 in a state in which the position of the nozzle 61 is fixed may be adopted. A configuration in which the movement mechanism 230 moves the stage 210 in the Z direction and the nozzle 61 in the X and Y directions, or a configuration in which the movement mechanism 230 moves the stage 210 in the X and Y directions and the nozzle 61 in the Z direction, may be adopted. Even with these configurations, the relative positional relationship between the nozzle 61 and the stage 210 can be changed.

Although only one head section 110 is shown in FIG. 1, the three dimensional molding device 100 may include a plurality of head sections 110. By providing the plurality of head sections 110, different types of plasticized materials can be ejected from each head section 110. Therefore, for example, the main body of the molded object and the support structure that supports the molded object can be molded with different types of plasticized materials.

The control section 300 is a control device that controls operation of the entire three dimensional molding device 100. The control section 300 is configured by a computer including one or a plurality of processors 310, a storage device 320 including a main storage device and an auxiliary storage device, and an input/output interface that inputs and outputs signals from and to outside. By executing a program stored in the storage device 320, the processor 310 controls the plasticizing section 30 and the movement mechanism 230 according to molding data acquired from the information process device 400, and molds the molded object on the stage 210. Note that the control section 300 may be realized by a configuration of a combination of circuits, instead of being configured by the computer.

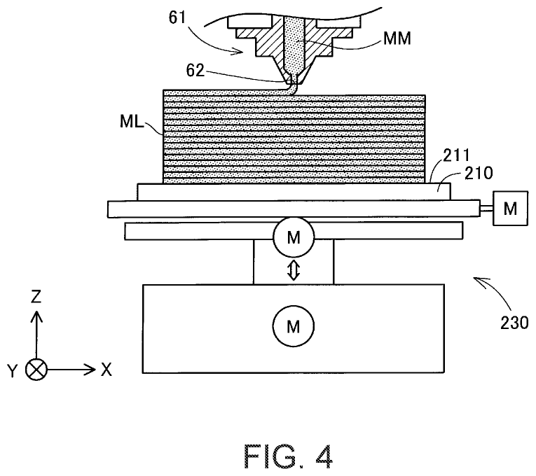

FIG. 4 is an explanatory diagram schematically showing how the three dimensional molding device 100 molds the molded object. In the three dimensional molding device 100, as described above, the raw material MR in the solid state is plasticized to produce a plasticized material MM. The control section 300, while maintaining the distance between the molding surface 211 of the stage 210 and the nozzle 61, changes the position of the nozzle 61 relative to the stage 210 in the direction along the molding surface 211 of the stage 210, and ejects the plasticized material MM from the nozzle 61. The plasticized material MM ejected from the nozzle 61 is continuously deposited in a moving direction of the nozzle 61. The distance between the molding surface 211 of the stage 210 and the nozzle 61 is also referred to as a vertical distance.

The control section 300 repeats the movement of the nozzle 61 to form layers ML. After forming one layer ML, the control section 300 moves the position of the nozzle 61 relative to the stage 210 in the Z direction, which is a stacking direction. Then, by further stacking layers ML on the layers ML formed so far, the molded object is molded.

For example, in a case where the nozzle 61 is moved in the Z direction when one layer ML is completed, or in a case where there are a plurality of independent molding portions in each layer, there is a situation in which the control section 300 temporarily interrupts the eject of the plasticized material from the nozzle 61. In this case, for example, the control section 300 closes the flow path 65 by the ejection amount adjustment mechanism 70 to stop the ejection of the plasticized material MM from the nozzle opening 62, and temporarily suctions the plasticized material in the nozzle 61 by the suction mechanism 75. For example, after changing the position of the nozzle 61, the control section 300 causes the ejection amount adjustment mechanism 70 to open the flow path 65 while discharging the plasticized material in the suction mechanism 75, thereby resuming the deposition of the plasticized material MM from the changed position of the nozzle 61.

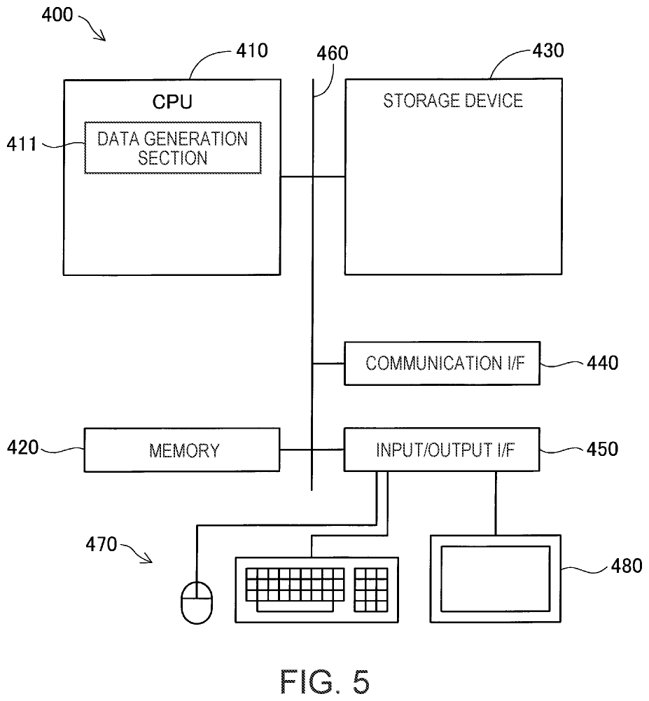

FIG. 5 is an explanatory diagram showing a schematic configuration of the information process device 400. The information process device 400 is configured as a computer in which a CPU 410, a memory 420, a storage device 430, a communication interface 440, and an input/output interface 450 are interconnected by a bus 460. An input device 470 such as a keyboard or a mouse, and a display section 480 such as a liquid crystal display are connected to the input/output interface 450. The information process device 400 is connected to the control section 300 of the three dimensional molding device 100 via the communication interface 440.

The CPU 410 functions as a data generation section 411 by executing a program stored in the storage device 430.

The data generation section 411 generates the molding data. The molding data is data representing information related to the movement path of the nozzle 61 with respect to the stage 210, the movement speed of the nozzle 61, the amount of the plasticized material ejected from the nozzle 61, the rotation speed of the screw 40, and the like. The data generation section 411 reads shape data representing the shape of the three dimensional molded object generated using a three dimensional CAD software or a three dimensional CG software and divides the shape of the three dimensional molded object into layers having a predetermined thickness. As the shape data, data in an STL format, an AMF format, or the like is used. The data generation section 411 generates the molding data by determining the movement path of the nozzle 61 and the amount of the plasticized material so as to fill each of the divided layers with the plasticized material. The molding data is represented by a G code, an M code, or the like.

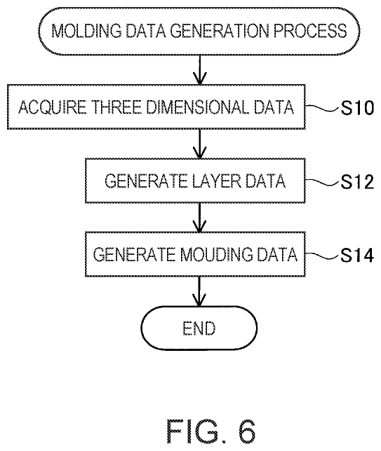

FIG. 6 is a flowchart of a molding data generation process executed by the data generation section 411. The molding data generation process is a process for generating the molding data used for molding the three dimensional molded object prior to molding the three dimensional molded object. In step S10, the data generation section 411 acquires three dimensional data representing the shape of the three dimensional molded object. The data generation section 411 acquires the three dimensional data such as three dimensional CAD data from outside via, for example, a network or a recording medium.

In step S12, the data generation section 411 analyzes the three dimensional data acquired in step S10 and generates layer data in which the three dimensional molded object is sliced into a plurality of layers along the XY plane. The slicing interval is set in accordance with the stack pitch.

In step S14, the data generation section 411 uses the layer data to generate the molding data, and ends this processing routine. The molding data includes path information representing a moving path of the ejection section 60, and the ejection amount information representing the ejection amount of the plasticized material in each moving path, and control information for controlling the ejection section 60, the plasticizing section 30, the movement mechanism 230, and the like.

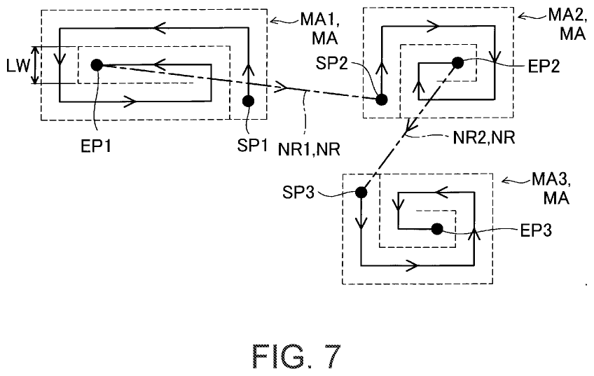

FIG. 7 is a diagram for explaining path information of the molding data. The path information of the molding data will be described by exemplifying a case where the movement path indicated by the path information of the molding data is the movement path shown in FIG. 7. Note that FIG. 7 is a schematic diagram for one layer molded by the molding data as viewed along the Z direction.

The molding data shown in FIG. 7 includes three molding portions MA, that is, a first molding portion MA1, a second molding portion MA2, and a third molding portion MA3. Solid line shown in the molding portions MA indicate an ejection path which is the movement path on which the nozzle 61 moves while ejecting the plasticized material from the nozzle opening 62. A dashed line shown in each molding portion MA indicates an outline of the linear molded object formed when the nozzle 61 moves along the movement path. The width of the linear molded object is also referred to as line width LW. One dot chain line shown in FIG. 7 indicates a non-ejection path NR, which is a movement path of the nozzle 61 moves after the ejection of the plasticized material from the nozzle opening 62 is stopped. The non-ejection path NR includes a first non-ejection path NR1 and a second non-ejection path NR2. The distance of the non-ejection path NR is also referred to as movement distance.

The first molding portion MA1 is molded by moving the nozzle 61 from a first ejection start position SP1 to a first ejection stop position EP1 while ejecting the plasticized material from the nozzle opening 62. After this, ejection of the plasticized material from the nozzle opening 62 is stopped, and the nozzle 61 moves from the first ejection stop position EP1 to the second ejection start position SP2 along the first non-ejection path NR1 indicated by one dot chain line. Thereafter, the nozzle 61 moves from the second ejection start position SP2 to the second ejection stop position EP2 while ejecting the plasticized material from the nozzle opening 62. As a result, the second molding portion MA2 is molded. Thereafter, the ejection of the plasticized material from the nozzle opening 62 is stopped, and the nozzle 61 moves from the second ejection stop position EP2 to the third ejection start position SP3 along the second non-ejection path NR2 indicated by the one dot chain line. Thereafter, the nozzle 61 moves from the third ejection start position SP3 to the third ejection stop position EP3 while ejecting the plasticized material from the nozzle opening 62. As a result, the third molding portion MA3 is molded. The path described above is set by the path information included in the molding data.

The first ejection stop position EP1, the second ejection stop position EP2, and the third ejection stop position EP3 are positions at which the ejection from the nozzle opening 62 is stopped, and thus are also referred to as ejection stop positions. Of the first ejection start position SP1, the second ejection start position SP2, and the third ejection start position SP3, the second ejection start position SP2 and the third ejection start position SP3 are positions at which the eject from the nozzle opening 62 is restarted, and thus are also referred to as ejection restart positions. More specifically, the ejection stop position is a position where the opening degree of the ejection amount adjustment mechanism 70 is set to 0%. The ejection restart position is a position at which a change in the opening degree of the ejection amount adjustment mechanism 70 is started. Note that the period of time from the start of the change of the opening degree of the ejection amount adjustment mechanism 70 to the time when the opening degree reaches 100% is approximately 20 ms.

As described above, the molding data includes control information in addition to the path information. The control information includes information on the movement speed of each of the ejection path and the non-ejection path NR. The movement speed is set for each of the ejection path and the non-ejection path NR. Further, the movement speed for each movement path, specifically, the first non-ejection path NR1 and the second non-ejection path NR2, is set independently.

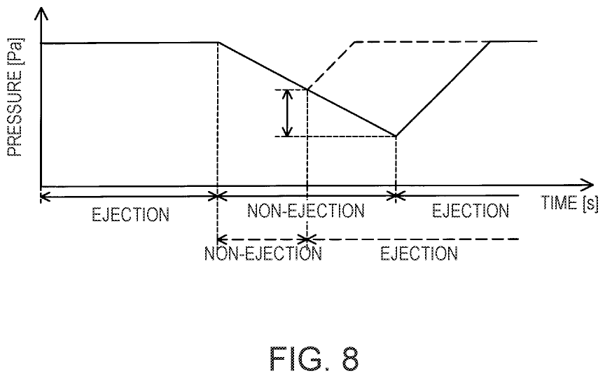

Incidentally, in the present embodiment, when the ejection of the plasticized material is stopped and the nozzle 61 moves, the flow path 65 is closed by the ejection amount adjustment mechanism 70, and the rotational speed of the screw 40 is lowered to 0 rpm. That is, the rotation of the screw 40 is stopped. Therefore, the pressure in the flow path 65 upstream of the ejection amount adjustment mechanism 70 decreases with time. FIG. 8 is a graph showing a relationship between time and pressure. The horizontal axis of FIG. 8 represents time. The vertical axis of FIG. 8 represents pressure, specifically, an ejection pressure, which is the pressure in the flow path 65 upstream of the ejection amount adjustment mechanism 70 and is the pressure in the vicinity of the ejection amount adjustment mechanism 70. As shown in FIG. 8, the ejection pressure during the ejection period, which is the period during which the plasticized material is ejected from the nozzle opening 62, is adjusted to be maintained substantially constant. On the other hand, the ejection pressure during the non-ejection period, which is a period during which the ejection of the plasticized material from the nozzle opening 62 is stopped, decreases at a substantially constant reduction rate in accordance with a decrease in the pressure in the flow path 65 upstream of the ejection amount adjustment mechanism 70. Note that the reduction rate is a reduction amount of the pressure per unit time.

As shown in FIG. 8, during the non-ejection period, the pressure in the flow path 65 upstream of the ejection amount adjustment drops at a substantially constant reduction rate, so the ejection pressure at the time of ejection restart changes depending on the length of the non-ejection period. As the ejection pressure varies, the line width LW at the ejection restart position also varies, and there is a concern that the molding accuracy may decrease. More specifically, as shown by dashed line in FIG. 8, when the non-ejection period is short, the ejection pressure at the time of ejection restart is higher than that in the case shown by solid line. In this way, when there is a difference in the time of the non-ejection period, there is a concern that the line width LW will vary and the molding quality will deteriorate. Therefore, the molding data according to the present embodiment is devised to reduce the variation in the time of the non-ejection period. Specifically, in the present embodiment, the control information of the molding data is created such that the time of the non-ejection period is constant regardless of the distance of the non-ejection path NR.

In step S14 shown in FIG. 6, the movement speed of the nozzle 61 in the non-ejection path NR is determined according to the movement distance from the ejection stop position to the ejection restart position. Specifically, the movement speed is determined so that the difference between a first movement time and a second movement time is within a predetermined range, wherein the first movement is the movement time in a first case where the movement distance from the ejection stop position to the ejection restart position is a first distance, and the second movement time is the movement time in a second case where the movement distance from the ejection stop position to the ejection restart position is a second distance, which is shorter than the first distance. In the present embodiment, the speed in the non-ejection path NR is determined so that the first movement time is equal to the second movement time.

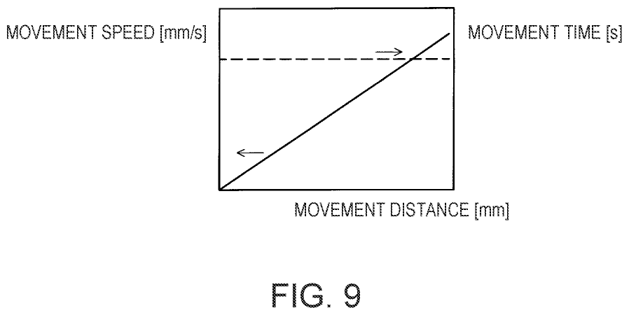

FIG. 9 is a graph showing a relationship between the movement distance, which is the distance of the non-ejection path NR, and the movement speed, and a relationship between the movement distance and the movement time. In step S14 shown in FIG. 6, the movement speed of the non-ejection path NR is determined using a relational equation between the movement distance and the movement speed shown by solid line in FIG. 9. As shown in FIG. 9, in the relational equation between the movement distance and the movement speed, the movement speed is proportional to the movement distance and the proportional constant is a positive value. As a result, as shown by dashed line in FIG. 9, the movement time during the non-ejection period is set to be constant regardless of the length of the movement distance. Therefore, even in a case where the molding data includes a plurality of non-ejection paths NR and the distances of the non-ejection paths NR differ from each other, since the movement time is set to be constant, variation in the ejection pressure at the time of ejection restart is suppressed. Therefore, the molding quality of the molded object can be improved. Further, in the present embodiment, the movement speed when moving along the non-ejection path NR, which is the longest among the plurality of non-ejection paths included in the molding data, is set to the highest speed within the speed range. Accordingly, it is possible to shorten the total time required for movement along the non-ejection path NR, compared to a case where the movement speed when moving along the non-ejection path NR with the longest distance is set to a speed lower than the highest speed in the speed range. Therefore, it is possible to suppress a decrease in manufacturing efficiency. Note that the total time required for the movement along the non-ejection path NR refers to the total time in all processes of the molding process for molding the three dimensional molded object.

Note that the method of determining the movement speed is not limited to the method using the relational equation. As another embodiment, the data generation section 411 may make the determination using, for example, a table representing the relationship between the movement distance and the movement speed.

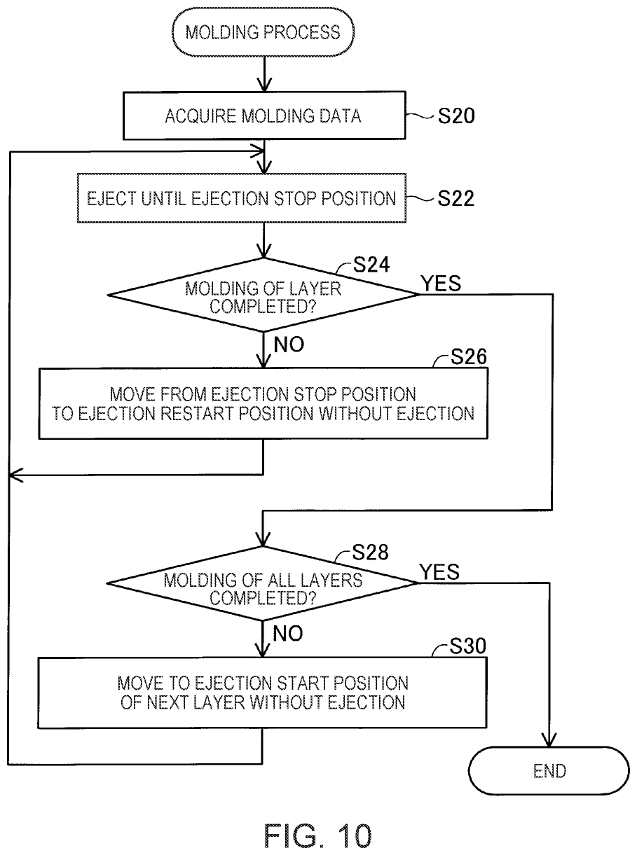

FIG. 10 is a flowchart of a molding process executed by the control section 300. The molding process is a process executed by the control section 300 using the molding data generated in the molding data generation process shown in FIG. 6. Along with a first step of plasticizing the material to produce the plasticized material and sending the plasticized material toward the nozzle opening 62 of the nozzle 61, the molding process is performed, thereby realizing the manufacturing method for the three dimensional molded object for molding the three dimensional molded object by stacking layers.

In the acquisition step S20, the control section 300 acquires molding data. The control section 300 reads the molding data for one layer among the plurality of layers constituting the three dimensional molded object from the acquired molding data. In the present embodiment, the control section 300 first reads the molding data of the layer positioned on the lowermost side among the plurality of layers constituting the three dimensional molded object.

In step S22 as a second process, the control section 300 forms the layer on the stage 210 by moving the nozzle 61 relative to the stage 210 while ejecting the plasticized material from the nozzle opening 62. Specifically, the control section 300 moves the nozzle 61 to the ejection start position at which the first molding of the layer is started, and then moves the nozzle 61 from the ejection start position to the ejection stop position. Thus, the plasticized material MM is ejected to stage 210 along the ejection path.

In step S24, the control section 300 determines whether or not the molding of the layer has been completed. In step S24, when it is determined that the molding of the layer is not completed, in step S26 as a third process, the control section 300 stops the ejection of the plasticized material from the nozzle opening 62 and relatively moves the nozzle from the ejection stop position to the ejection restart position. In detail, in step S26, the control section 300 stops the ejection of the plasticized material from the nozzle opening 62 by adjusting the opening areas of the ejection amount adjustment mechanism 70, and reduces the rotational speed of the screw 40 to 0 rpm. In step S26, the control section 300 performs a first control of moving the nozzle 61 relative to the stage 210 in accordance with the movement speed included in the molding data. Further, in the present embodiment, as the first control, speed control is performed so that the longer the movement distance from the ejection stop position to the ejection restart position, the higher the movement speed is set. Therefore, it is possible to suppress the variation of the ejection pressure when the ejection is restarted in the next step S22, and to suppress variation of the ejection amount when ejection is restarted.

After performing step S26, the control section 300 returns the process to step S22 in order to perform molding of the next movement path.

If it is determined in step S24 that molding of the layer has been completed, the control section 300 determines in step S28 whether or not the molding of all the layers has been completed. When it is determined that the molding of all the layers is not completed, then in order to mold the next layer, in step S30 the control section 300 moves the nozzle 61 to the ejection start position of the next layer without ejecting the plasticized material from the nozzle opening 62. After performing step S30, control section 300 returns the process to step S22.

In step S28, in a case where it is determined that the molding of all the layers is completed, the control section 300 ends this processing routine.

According to the first embodiment described above, the three dimensional molded object is molded by performing the first process, step S22 as the second process, and step S26 as the third process. In step S26, the first control is performed to regulate the position of the nozzle 61 so that the difference between the movement time when the movement distance from the ejection stop position to the ejection restart position is a first distance and the movement time when the movement distance is a second distance, which is shorter than the first distance, is within a predetermined range. As a result, even when the movement distance from the ejection stop position to the ejection restart position is not constant, since the movement time from the ejection stop position to the ejection restart position is controlled to be within a predetermined range, it is possible to suppress variations in the pressure in the flow path 65 upstream of the ejection amount adjustment mechanism 70. Therefore, the variation in the ejection amount at the time of ejection restart is suppressed, and it is possible to suppress a decrease in the molding accuracy of the molded object.

In step S26, the movement of the nozzle 61 is controlled so that the difference between the first movement time, which is the movement time when the non-ejection path NR is the first distance, and the second movement time, which is the movement time when the non-ejection path NR is the second distance shorter than the first distance, becomes zero, that is, the first movement time is equal to the second movement time. Therefore, since the movement time of the non-ejection path NR can be made constant, it is possible to improve the effect of suppressing the variation in the pressure in the flow path 65 upstream of the ejection amount adjustment mechanism 70.

In step S26, as the first control, speed control is performed in which the longer the movement distance is longer, which is the distance of the non-ejection path NR, the higher the movement speed becomes. Therefore, by adjusting the movement speed, the movement time of the non-ejection path NR can be made constant.

Compared to the case of changing the moving path of a non-ejection path NR having a short distance so that the path length of the moving path of the nozzle 61 is longer in order to adjust the movement time, it is possible to suppress an increase in the calculation load for the creation of the molding data because it is not necessary to perform a complex calculation for the creation of the molding data. As a specific example of changing the moving path so that the path length of the moving path of the nozzle 61 becomes longer, it is possible to set the moving path to a path along a curve connecting the ejection stop position and the ejection restart position, rather than to a straight line connecting the ejection stop position and the ejection restart position.

The movement speed when moving along the non-ejection path NR that is the longest among the plurality of non-ejection paths NR included in the molding data, is set to the highest speed within the speed range. Therefore, it is possible to shorten the total time required for the movement along the non-ejection path NR in the molding process of the three dimensional molded object compared to a case where the movement speed is set to a speed lower than the highest speed in the speed range when moving along the non-ejection path NR with the longest distance. Therefore, it is possible to suppress a decrease in manufacturing efficiency.

In step S22, control is performed to reduce the rotational speed of the screw 40 to 0 rpm, that is, to stop the rotation of the screw 40. Thus, during the movement time, it is possible to avoid an increase in the pressure in the flow path 65 upstream of the ejection amount adjustment mechanism 70, and it is possible to avoid the line width LW at the ejection restart being significantly thicker than the target width.

### B. Second Embodiment

In the first embodiment, as the first control, speed control for adjusting the movement speed in the non-ejection path NR is performed in order to make the movement time from the ejection stop position to the ejection restart position constant regardless of the distance. In the second embodiment, as the first control, a first stage control and a second stage control for moving the nozzle 61 in the Z direction, and a third stage control for moving the nozzle 61 from the ejection stop position to the ejection restart position are performed. Thus, similarly to the speed control, the movement time from the ejection stop position to the ejection restart position is adjusted to be constant. The same structures and the same processing steps as those of the first embodiment are denoted by the same reference symbols, and detailed description thereof will be appropriately omitted.

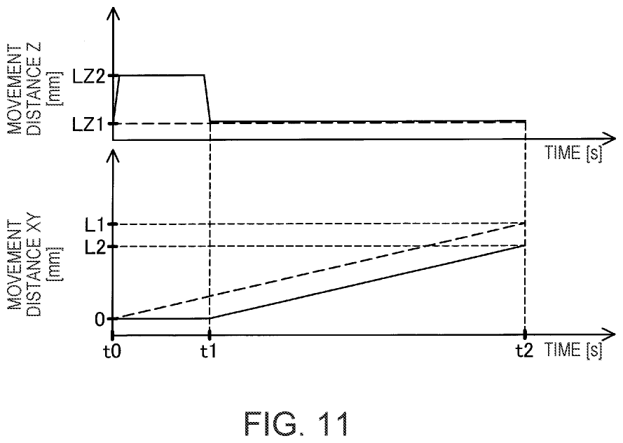

FIG. 11 is a diagram showing the movement of the nozzle 61 of the non-ejection path NR in the present embodiment. The horizontal axis of the upper graph of FIG. 11 is time, and the vertical axis is the movement distance of the nozzle 61 in the Z direction. The horizontal axis of the lower graph of FIG. 11 is time, and the vertical axis is the movement distance of the nozzle 61 in the XY plane. In the two graphs of FIG. 11, the time axes of the graphs are aligned such that the elapsed times from the time t0 coincide with each other. At the time t0 of FIG. 11, the nozzle 61 is positioned at the ejection stop position. At the time t2 of FIG. 11, the nozzle 61 is positioned at the ejection restart position. The distance between the nozzle 61 and the stage 210 at the ejection stop position is a first vertical distance LZ1. Here, the distance between the nozzle 61 and the stage 210 is specifically a distance between the molding surface 211 of the stage 210 and the nozzle 61. In FIG. 11, a characteristic line indicated by dashed line is a characteristic line when the movement distance is the first distance L1. In FIG. 11, a characteristic line indicated by solid line is a characteristic line of when the movement distance is the second distance L2, which is shorter than the first distance L1.

As shown in FIG. 11, in the moving path of the molding data, if there is a movement distance of the non-ejection path with a first distance L1 and a second distance L2, which is shorter than the first distance L1, then in the case of moving the second distance L2, the third stage control for moving the nozzle 61 in the XY plane direction is performed after the first and second stage controls for moving the nozzle 61 in the Z direction are performed at the ejection start position. Accordingly, in a case where the non-ejection path NR is short, the time of the non-ejection period becomes longer compared to a case where only the third stage control is performed, and thus it is possible to reduce the difference between the first movement time and the second movement time.

The first stage control, the second stage control, and the third stage control will be described in detail with reference to FIG. 11. In the period from time t0 to time t1 in FIG. 11, the first stage control and the second stage control are performed. In the first stage control, the nozzle 61 is moved in the Z direction so as to have the second vertical distance LZ2 longer than the first vertical distance LZ1. Thereafter, in the second stage control, the nozzle 61 is moved in the Z direction from the position of the second vertical distance LZ2 to the position of the first vertical distance LZ1. The difference between the first vertical distance LZ1 and the second vertical distance LZ2 is, for example, about 0.5 mm. The temperature of the nozzle 61 is high enough that the fluidity of the plasticized material is not impaired. Therefore, by performing the first stage control, it is possible to reduce the possibility that the molded object already molded on the stage 210 is deformed by the heat radiated from the nozzle 61.

After the first stage control and the second stage control are performed, the third stage control is performed from time t1 to time t2. In the present embodiment, when the distance of the non-ejection path NR is the first distance L1, the nozzle 61 is moved toward the ejection restart position at the same movement speed from time t0 to time t2. In the present embodiment, the movement speed from the time t1 to the time t2 when the distance of the non-ejection path NR is the second distance L2 is the same as the movement speed when the distance of the non-ejection path NR is the first distance L1. As shown in FIG. 11, in the present embodiment, whether the distance of the non-ejection path NR is the second distance L2 or the distance of the non-ejection path NR is the first distance L1, the control information of the molding data is set so that each nozzle 61 is positioned at the ejection restart position at the time t2.

According to the second embodiment described above, as the first control, when the distance of the non-ejection path NR is the second distance L2, which is shorter than the first distance L1, the first stage control and the second stage control for moving the nozzle 61 in the Z direction, and the third stage control for moving the nozzle 61 along the XY plane are performed. Therefore, the difference between the movement time when the non-ejection path NR distance is the first distance L1 and the movement time when the non-ejection path NR distance is the second distance L2 can be reduced.

### C. Third Embodiment

In the first embodiment, the speed control is applied to the non-ejection path for the entire molding data. In the third embodiment, the speed control is applied to part of the molding data. The same structures and the same processing steps as in the above embodiments are denoted by the same reference symbols, and detailed description thereof will be appropriately omitted.

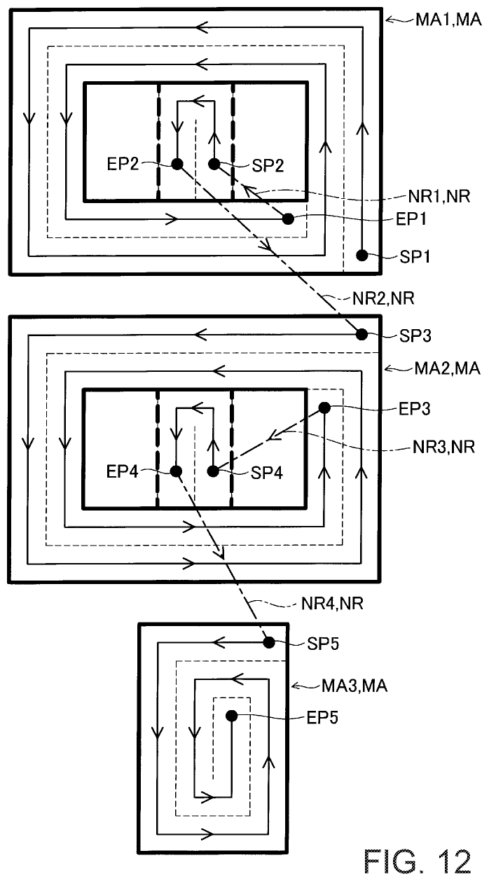

FIG. 12 is a diagram for explaining the molding data, and is a diagram similar to FIG. 7. The molding data shown in FIG. 12 includes three molding portions MA, that is, the first molding portion MA1, the second molding portion MA2, and the third molding portion MA3. The first molding portion MA1 and the second molding portion MA2 include an outer shell region as a first molding region and an inner region as a second molding region. The third molding portion MA3 includes only the outer shell region as the first molding region. In FIG. 12, the outer shell region is indicated by thick line, and the inner region is indicated by dashed thick line. The outer shell region is a region that forms an outer shell of the molding portion MA.

The outer shell region is a region that forms the outline of the molded object. Therefore, when the molding accuracy of the outer shell region is low, the molding accuracy of the molded object is also low. Therefore, the molding accuracy of the outer shell region is set according to the molding accuracy of the molded object. On the other hand, since the inner region is a region inside the outer shell region, in the present embodiment, the molding accuracy of the inner region is set to be lower than the molding accuracy of the outer shell region. Specifically, in the present embodiment, the data generation section 411 adjusts the molding accuracy of the inner region to be lower than the molding accuracy of the outer shell region and generates the molding data.

The outer shell region of the first molding portion MA1 is molded by moving the nozzle 61 from the first ejection start position SP1 to the first ejection stop position EP1 while ejecting the plasticized material from the nozzle opening 62. The inner region of the first molding portion MA1 is molded by moving the nozzle 61 from the second ejection start position SP2 to the second ejection stop position EP2 while ejecting the plasticized material from the nozzle opening 62. The outer shell region of the second molding portion MA2 is molded by moving the nozzle 61 from the third ejection start position SP3 to the third ejection stop position EP3 while ejecting the plasticized material from the nozzle opening 62. The inner region of the second molding portion MA2 is molded by moving the nozzle 61 from the fourth ejection start position SP4 to the fourth ejection stop position EP4 while ejecting the plasticized material from the nozzle opening 62. The third molding portion MA3 is molded by moving the nozzle 61 from the fifth ejection start position SP5 to the fifth ejection stop position EP5 while ejecting the plasticized material from the nozzle opening 62.

The molding data includes four non-ejection paths NR, that is, a first non-ejection path NR1, a second non-ejection path NR2, a third non-ejection path NR3, and a fourth non-ejection path NR4. The first non-ejection path NR1 is a path from the first ejection stop position EP1 to the second ejection start position SP2. The second non-ejection path NR2 is a path from the second ejection stop position EP2 to the third ejection start position SP3. The third non-ejection path NR3 is a path from the third ejection stop position EP3 to the fourth ejection start position SP4. The fourth non-ejection path NR4 is a path from the fourth ejection stop position EP4 to the fifth ejection start position SP5.

In the present embodiment, when the first control is performed in a case where the ejection restart position is the molding ejection start position of the outer shell region, and a second control is performed in a case where the ejection restart position is the molding ejection start position of the inner region, the second control performs control such that the shorter that the movement distance is from the ejection stop position to the ejection restart position, the shorter that the movement time is. In the present embodiment, in the second control, the nozzle 61 is moved from the ejection stop position to the ejection restart position at a predetermined speed. Specifically, the third ejection start position SP3 as the ejection restart position is the molding ejection start position in the outer shell region of the second molding portion MA2. The fifth ejection start position SP5 as the ejection restart position is the molding ejection start position of the third molding portion MA3, which is the outer shell region. Therefore, the first control is performed on the second non-ejection path NR2 and the fourth non-ejection path NR4. Specifically, also in the present embodiment, similarly to the first embodiment, the speed control is performed as the first control. That is, since the length of the second non-ejection path NR2 is longer than the length of the fourth non-ejection path NR4, the movement speed of the second non-ejection path NR2 is set to be higher than the movement speed of the fourth non-ejection path NR4. Accordingly, it is possible to reduce the difference between the ejection pressure at the third ejection start position SP3 and the ejection pressure at the fifth ejection start position SP5. Therefore, the difference between the ejection amount at the third ejection start position SP3 and the ejection amount at the fifth ejection start position SP5 is reduced, and it is possible to suppress the lowering of the molding accuracy of the molded object.

On the other hand, the second ejection start position SP2 as the ejection restart position is the molding start position of the inner region of the second molding portion MA2. The fourth ejection start position SP4 as the ejection restart position is the molding start position of the inner region of the second molding portion MA2. Therefore, the second control is performed on the first non-ejection path NR1 and the third non-ejection path NR3. Specifically, the length of the first non-ejection path NR1 and the length of the third non-ejection path NR3 are different from each other, but the movement speed of the first non-ejection path NR1 and the movement speed of the third non-ejection path NR3 are set to the same speed. Since the distance of the first non-ejection path NR1 is shorter than the distance of the third non-ejection path NR3, the movement time of the nozzle 61 of the first non-ejection path NR1 is shorter than the movement time of the nozzle 61 of the third non-ejection path NR3. In the present embodiment, the movement speed of the first non-ejection path NR1 and the movement speed of the third non-ejection path NR3 are set to the highest speed in the speed range.

In speed control, when the length of the non-ejection path NR is the second distance L2 that is shorter than the first distance L1, the movement speed of the non-ejection path NR that is the second distance L2 is set to a speed that is lower than the movement speed of the non-ejection path NR that is the first distance L1. Therefore, the movement time for the non-ejection path NR that is the second distance L2 becomes longer than the case of moving at the movement speed of the non-ejection path NR that is the first distance L1. Therefore, by limiting the portion where the speed control is performed, it is possible to suppress an increase in the molding time while maintaining the molding accuracy of the molded object.

According to the third embodiment described above, when the ejection restart position is the molding start position of the outer shell region, then speed control of the first control is performed, and when the ejection restart position is the molding start position of the inner region, then the second control, which shortens the movement time the shorter that the movement distance is, is performed instead of the first control. Accordingly, compared to a case where the first control is performed on all the molding regions, it is possible to suppress an increase in the molding time while maintaining the molding accuracy.

### D. Other Embodiments

(D1) In the first embodiment, the speed in the non-ejection path NR is determined so that the first movement time is equal to the second movement time. The first control may be performed such that the difference between the first movement time and the second movement time is within a predetermined range. The predetermined range, that is, the difference between the first movement time and the second movement time, is desirably smaller because the smaller the variation in the ejection amount at the time of ejection restart will become. The predetermined range is, for example, 10% of the first movement time. As in the first embodiment, when the first movement time is equal to the second movement time, the effect of suppressing the variation in the ejection amount at the time of ejection restart is further improved, which is more desirable.

(D2) In the first embodiment, as the first control, when the length of the non-ejection path NR is the second distance L2, which is shorter than the first distance L1, the speed control is performed in which the movement speed of the non-ejection path NR that is the second distance L2 is set to a speed that is lower than the movement speed of the non-ejection path NR that is the first distance L1. As another embodiment, for example, when the distance of the movement path is the second distance L2, the movement path from the ejection stop position to the ejection restart position may not be the straight line path connecting the ejection stop position and the ejection restart position, but may be a path having a distance longer than the straight line distance such as the curve or a polygonal line connecting the ejection stop position and the ejection restart position. In this case, even if the movement speed of the non-ejection path NR that is the second distance L2 is set to be the same as the movement speed of the non-ejection path NR that is the first distance L1 the movement time can be lengthened since the movement distance is increased. Therefore, the difference between the first movement time and the second movement time can be reduced. In a case where the distance of the movement path is the second distance L2, the movement time may be lengthened by providing a standby time without movement at a position on the movement path from the ejection stop position to the ejection restart position.

(D3) In the second embodiment, the first stage control, the second stage control, and the third stage control are performed in this order. This is not a limitation and the control section 300 may move the nozzle 61 in the Z direction after moving the nozzle 61 from the ejection stop position to the ejection restart position. That is, as the first control, the third stage control, the first stage control, and the second stage control may be performed in this order. The control section 300 may move in a state of the nozzle 61 to the second vertical distance LZ2, move it in the XY plane direction, and then move it to the first vertical distance LZ1. That is, as the first control, the first stage control, the third stage control, and the second stage control may be performed in this order. Note that, in some cases, the control for moving the nozzle 61 in the Z direction is performed to avoid interference with a molded object that has already been formed on the stage 210. In the second embodiment, in a case where the movement distance from the ejection stop position to the ejection restart position is the first distance L1, the movement of the nozzle 61 in the Z direction is not performed. As another embodiment, in a case where the movement distance from the ejection stop position to the ejection restart position is the first distance L1, the movement of the nozzle 61 in the Z direction may be performed. In this case, the difference between the first movement time and the second movement time can be reduced by setting the time for positioning the nozzle 61 at the second vertical distance LZ2 in a second case, in which the movement distance is the second distance L2, to be longer than the time for positioning the nozzle 61 at the second vertical distance LZ2 in a first case, in which the movement distance is the first distance L1. In the second embodiment, regardless of the movement distance from the ejection stop position to the ejection restart position, the movement speed for moving the nozzle 61 in the XY plane direction from the ejection stop position to the ejection restart position is the same, although the movement distances may differ from each other.

(D4) In the third embodiment, the first control is performed on the outer shell region as the first molding region, and the second control is performed on the inner region as the second molding region. As another embodiment of the second molding region, there are regions referred to as rafts or supports. A raft is a molding region that functions as a base, and is a region that is molded in order to fix the three dimensional molded object to the stage 210 during molding. A support is a region that is molded to support the three dimensional molded object during molding. In a case where the second molding region is a raft or a support, the first molding region is the target molding region. Note that a raft and a support are separated from the molding region after the molding is completed. The molding accuracy of the raft and the support is set to be lower than the molding accuracy of the target molding region. Therefore, the first control is performed on the target molding region, and the second control is performed on the raft or the support, thereby achieving the same effect as that of the third embodiment.

(D5) In the first embodiment, the rotational speed of the screw 40 is lowered to 0 rpm during the non-ejection period in which the flow path 65 is closed by the ejection amount adjustment mechanism 70. That is, during the non-ejection period, the rotation of the screw 40 is stopped. This is not a limitation and in the non-ejection period, the rotational speed of the screw 40 may be rotated at the rotational speed greater than 0 rpm. By reducing at least the rotational speed of the screw 40 during the non-ejection period, the ejection amount adjustment mechanism 70 can suppress an increase in the pressure in the upstream flow path 65.

In the third embodiment, as the second control, control of moving the nozzle 61 from the ejection stop position to the ejection restart position at a predetermined speed is performed. The nozzle 61 is accelerated in the moving direction from a stopped state at the ejection stop position until it reaches the target speed. Therefore, when the distance from the ejection stop position to the ejection restart position is short, the ejection restart position may be reached before the speed of the nozzle 61 reaches the steady state. Therefore, as the second control, control may be performed in which the nozzle 61 is moved by accelerating from the ejection stop position to the ejection restart position.

### E. Other Aspects

The present disclosure is not limited to the above described embodiments, and can be realized in various configurations without departing from the spirit thereof. For example, the technical features of the embodiments corresponding to the technical features in each aspect described below can be appropriately replaced or combined in order to solve a part or all of the problems described above or in order to achieve a part or all of the effects described above. Unless the technical features are described as essential in the present specification, the technical features can be appropriately deleted.

(1) According to an aspect of the present disclosure, there is provided the manufacturing method for the three dimensional molded object for molding the three dimensional molded object by stacking layers.

This manufacturing method includes a first step of plasticizing a material to produce a plasticized material and sending the plasticized material toward a nozzle opening of a nozzle;
a second step of forming a layer on a stage by moving the nozzle relative to the stage while ejecting the plasticized material from the nozzle opening; and a third step of stopping the ejection of the plasticized material from the nozzle opening during a movement time in which the nozzle relatively moves from an ejection stop position at which ejection from the nozzle opening is stopped to an ejection restart position positioned in the same layer as the ejection stop position that is the ejection restart position where ejection from the nozzle opening is restarted, wherein in the third step ejection of the plasticized material from the nozzle opening is stopped by adjusting an opening area of a flow path through which the plasticized material flows toward the nozzle opening and a first control is performed to control the movement of the nozzle with respect to the stage such that a difference between a first movement time, which is the movement time in a first case where a movement distance, which is a distance from the ejection stop position to the ejection restart position, is a first distance, and a second movement time, which is the movement time in a second case where the movement distance is a second distance shorter than the first distance, is within a predetermined range.

According to this aspect, even when the distance from the ejection stop position to the ejection restart position is not constant, since the movement time is controlled to be within a predetermined range, it is possible to suppress variation of pressure in the flow path upstream of the adjustment point of the opening area after the movement time has elapsed. Therefore, it is possible to suppress variations in the ejection amount of the plasticized material at the ejection restart position.

(2) The above aspect may be such that the first movement time is equal to the second movement time.

According to this aspect, since it is possible to equalize the time during which the ejection of the plasticized material from the nozzle opening is stopped, it is possible to improve the effect of suppressing variation in pressure in the flow path upstream of the adjustment place of the opening area.

(3) The above aspect may be such that as the first control, a speed control is performed to control the movement speed of the nozzle in the first case to be larger than the movement speed in the second case.

According to this aspect, it is possible to reduce the difference between the first movement time and the second movement time by adjusting the movement speed. It is possible to suppress an increase in the calculation load as compared with the case where the movement path of the nozzle is changed so that the path length becomes longer in order to adjust the movement time.

(4) The above aspect may be such that the following is performed as the first control a first stage control for relatively moving the nozzle with respect to the stage from a first vertical distance, which is the distance between the nozzle and the stage at the ejection stop position, to a second vertical distance, which is longer than the first vertical distance in the second case, a second stage control for relatively moving the nozzle with respect to the stage from the position of the second vertical distance to the position of the first vertical distance, and a third stage control for relatively moving the nozzle with respect to the stage from the ejection stop position to the ejection restart position.

According to this aspect, in the second case, the difference between the first movement time and the second movement time can be reduced by performing the first stage control and the second stage control.

(5) The above aspect may further include an acquisition step of acquiring molding data, wherein the molding data includes a first molding region and a second molding region in which molding accuracy is set lower than molding accuracy of the first molding region, when the ejection restart position is a molding start position of the first molding region, then the first control is performed, and when the ejection restart position is the molding start position of the second molding region, then instead of the first control, a second control is performed in which the movement time is controlled to be shorter as the movement distance is shorter.

According to this aspect, by appropriately setting the predetermined speed, it is possible to suppress an increase in the molding time while maintaining the molding accuracy, compared to a case where the first control is performed on the entire range of the molding data.

(6) The above aspect may further include an acquisition step of acquiring molding data in which a plurality of non-ejection paths are set, wherein each non-ejection path of the plurality of non-ejection paths is a path from the ejection stop position to the ejection restart position, the movement speed is settable within a predetermined speed range, and in the speed control, when movement is in the non-ejection path having the longest distance among the plurality of non-ejection paths, the movement speed is set to the highest speed in the speed range.

According to this aspect, the total time for which the ejection of the plasticized material from the nozzle opening is stopped can be made shorter than in the case where the movement speed of the path having the longest distance of the non-ejection path for stopping and moving the ejection of the plasticized material from the nozzle opening is set to a speed lower than the highest speed in the speed range. Therefore, it is possible to suppress a decrease in manufacturing efficiency.

(7) The above aspect may be such that in the first step, the plasticized material is produced by feeding the material to a plasticizing section provided with a screw and a motor for rotating the screw and in the third step, either control for stopping the rotational speed of the screw or control for reducing the rotational speed of the screw is performed during the movement time.

According to this aspect, it is possible to suppress an increase in the pressure of the flow path on the upstream from the adjustment place of the opening area, and to suppress the ejection amount at the time of ejection restart from being significantly larger than the target amount.

The present disclosure is not limited to the above described manufacturing method for the three dimensional modeling, and can be realized by various aspects such as the three dimensional molding device, the three dimensional molding system, a computer program, and a non-transitory tangible recording medium in which the computer program is recorded in a computer-readable manner.

What is claimed is:

1. A manufacturing method for a three dimensional molded object for molding the three dimensional molded object by stacking layers, the method comprising:
a first step of plasticizing a material to produce a plasticized material and sending the plasticized material toward a nozzle opening of a nozzle;
a second step of forming a layer on a stage by moving the nozzle relative to the stage while ejecting the plasticized material from the nozzle opening; and
a third step of stopping the ejection of the plasticized material from the nozzle opening during a movement time in which the nozzle relatively moves with respect to the stage from an ejection stop position at which ejection from the nozzle opening is stopped to an ejection restart position that is positioned in the same layer as the ejection stop position and that is where ejection from the nozzle opening is restarted, wherein
in the third step
ejection of the plasticized material from the nozzle opening is stopped by adjusting an opening area of a flow path through which the plasticized material flows toward the nozzle opening and
a first control is performed to control the movement of the nozzle with respect to the stage such that a difference between a first movement time and a second movement time is within a predetermined range, the first movement time being the movement time in a first case where a movement distance, which is a distance from the ejection stop position to the ejection restart position, is a first distance, and the second movement time being the movement time in a second case where the movement distance is a second distance shorter than the first distance.

2. The method for manufacturing the three dimensional molded object according to claim 1, wherein
the first movement time is equal to the second movement time.

3. The method for manufacturing the three dimensional molded object according to claim 1, wherein
as the first control, a speed control is performed to control the movement speed of the nozzle in the first case to be larger than the movement speed in the second case.

4. The method for manufacturing the three dimensional molded object according to claim 1, wherein
the following is performed as the first control
a first stage control for relatively moving the nozzle with respect to the stage from a first vertical distance, which is the distance between the nozzle and the stage at the ejection stop position, to a second vertical distance, which is longer than the first vertical distance in the second case, a second stage control for relatively moving the nozzle with respect to the stage from the position of the second vertical distance to the position of the first vertical distance, and a third stage control for relatively moving the nozzle with respect to the stage from the ejection stop position to the ejection restart position.

5. The method for manufacturing the three dimensional molded object according to claim 1, further comprising:
an acquisition step of acquiring molding data, wherein
the molding data includes a first molding region and a second molding region in which molding accuracy is set lower than molding accuracy of the first molding region,
when the ejection restart position is a molding start position of the first molding region, then the first control is performed, and
when the ejection restart position is the molding start position of the second molding region, then instead of the first control, a second control is performed in which the movement time is controlled to be shorter as the movement distance is shorter.

6. The method for manufacturing the three dimensional molded object according to claim 3, further comprising:
an acquisition step of acquiring molding data in which a plurality of non-ejection paths are set, wherein
each non-ejection path of the plurality of non-ejection paths is a path from the ejection stop position to the ejection restart position,
the movement speed is settable within a predetermined speed range, and
in the speed control, when movement is in the non-ejection path having the longest distance among the plurality of non-ejection paths, the movement speed is set to the highest speed in the speed range.

7. The method for manufacturing the three dimensional molded object according to claim 1, wherein
in the first step, the plasticized material is produced by feeding the material to a plasticizing section provided with a screw and a motor for rotating the screw and
in the third step, rotational speed of the screw is reduced during the movement time.
